(19) United States
(12) Patent Application Publication
(10) Pub. No.: US 2007/0248877 A1
(43) Pub. Date: Oct. 25, 2007

(54) GRADIENT NON-LINEAR ADAPTIVE POWER ARCHITECTURE AND SCHEME

(76) Inventors: Jaber Abu Qahoug, Beaverton, OR (US); Lilly Huang, Portland, OR (US); Raviprakash Nagaraj, Tigard, OR (US)

Correspondence Address: KACVINSKY LLC;C/O INTELLEVATE, P.O. BOX 52050, MINNEAPOLIS, MN, 55402, US

(21) Appl. No.: 11/691,331

(22) Filed: Mar. 26, 2007

Related U.S. Application Data
(63) Continuation-in-part of application No. 11/394,910, filed on Mar. 31, 2006.

(51) Int. Cl. H01M 2/00; G05F 5/00

(52) U.S. Cl. 429/121; 700/295

(57) ABSTRACT

Techniques related to a power module employing multiple power sub-modules are described. More specifically, an embodiment combines and controls multiple power sub-modules of varying characteristics to improve the overall efficiency of the power module across varying load currents, power outputs, input voltages, and other operating conditions. Moreover, the power module may employ an adaptive non-linear and non-uniform current/power sharing among its power sub-modules. Other embodiments are described and claimed.

### RELATED CASES

The present application is a Continuation-In-Part of, and claims priority to, commonly owned U.S. patent application Ser. No. 11/394,910 titled “GRADIENT NON-LINEAR ADAPTIVE POWER ARCHITECTURE AND SCHEME” filed on Mar. 31, 2006, the entirety of which is hereby incorporated by reference.

### BACKGROUND

Power architectures and power conversion techniques may be available to lower power consumption for certain devices under certain operations. While particularly important to devices relying on batteries as power sources, power-reducing architectures and techniques may further benefit any device that includes DC to DC voltage regulation, AC to DC conversion, DC to AC conversion, or AC to AC voltage regulation. Paralleled or interleaved modules may sometimes be used to process power in parallel to improve thermal management and dynamic performance. Such a paralleled module may employ uniform or equal (and linear) current/power sharing between the paralleled sub-modules. Even when one or more of the paralleled sub-modules is turned OFF, the rest of the sub-modules may still maintain equal current sharing and are further turned OFF in an ordered fashion one following the other. This may not always result in best efficiency and performance.

Power conversion modules for the devices may have different efficiencies based on the load demand and other operating conditions. For example, a power conversion module may be efficient at high current or power loads relative to the maximum power or current load (e.g., approximately greater than 40% of the maximum power or current load) of which the power conversion module is capable. However, at lower current or power loads relative to the maximum power or current load (e.g., approximately less than 20% of the maximum power or current load) the efficiency of the power conversion module may decrease. Accordingly, there may be a need for improvements in power reduction techniques for power conversion and power delivery, and in particular power reduction techniques for power conversion and power delivery within a power range typical for the device supplied.

### BRIEF DESCRIPTION OF THE DRAWINGS

FIG. 1 illustrates a system including a power module of an embodiment.

FIG. 2 illustrates a power source and a power module of an embodiment.

FIG. 3 illustrates the useful efficiency range of a conventional power module.

FIG. 4 illustrates the gradient non-linear adaptive power module of an embodiment.

FIG. 5 illustrates the gradient non-linear adaptive power module of an alternate embodiment.

FIG. 6 illustrates the efficiencies of individual power sub-modules.

FIG. 7 illustrates the collective efficiencies of N power sub-modules of an embodiment.

FIG. 8 illustrates a graph depicting an embodiment employing non-linear and non-uniform current/power sharing.

FIG. 9 illustrates the logic flow of an embodiment.

### DETAILED DESCRIPTION

Embodiments of a gradient non-linear adaptive power architecture and scheme will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Various embodiments may be generally directed to a power module employing multiple power sub-modules. More specifically, an embodiment combines and controls multiple power sub-modules of varying characteristics to improve the overall efficiency of the power module (e.g., combination of individual power sub-modules) across varying load currents, power outputs, input voltages, and other operating conditions. Further, power sub-modules of the power module of an embodiment may be individually controlled (e.g., enabled, disabled, or altered) in response to the load current, power required at the power module output, or other operating condition(s). Moreover, the power module may employ an adaptive non-linear and non-uniform current/power sharing among its power sub-modules.

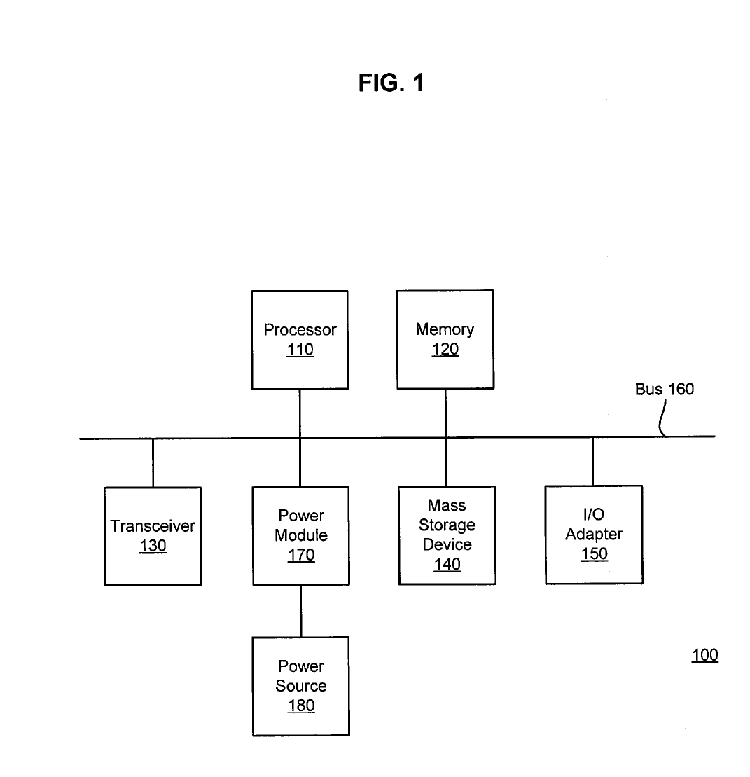

FIG. 1 illustrates a partial block diagram for a device 100. Device 100 may comprise several elements, components or modules, collectively referred to herein as a “module.” A module may be implemented as a circuit, an integrated circuit, an application specific integrated circuit (ASIC), an integrated circuit array, a chipset comprising an integrated circuit or an integrated circuit array, a logic circuit, a memory, an element of an integrated circuit array or a chipset, a stacked integrated circuit array, a processor, a digital signal processor, a programmable logic device, code, firmware, software, and any combination thereof. Although FIG. 1 is shown with a limited number of modules in a certain topology, it may be appreciated that device 100 may include more or less modules in any number of topologies as desired for a given implementation. The embodiments are not limited in this context.

In one embodiment, device 100 may comprise a mobile device. For example, mobile device 100 may comprise a computer, laptop computer, ultra-laptop computer, handheld computer, cellular telephone, personal digital assistant (PDA), wireless PDA, combination cellular telephone/PDA, portable digital music player, pager, two-way pager, station, mobile subscriber station, and so forth. The embodiments are not limited in this context.

In one embodiment, device 100 may include a processor 110. Processor 110 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 110 may be implemented as a general purpose processor, such as a processor made by Intel® Corporation, Santa Clara, Calif. Processor 110 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, the device 100 may include a memory 120 to couple to processor 110. Memory 120 may be coupled to processor 110 via bus 160, or by a dedicated bus between processor 110 and memory 120, as desired for a given implementation. Memory 120 may be implemented using any machine-readable or computer-readable media capable of storing data, including both volatile and non-volatile memory. For example, memory 120 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 120 may be included on the same integrated circuit as processor 110, or alternatively some portion or all of memory 120 may be disposed on an integrated circuit or other medium, for example a hard disk drive, that is external to the integrated circuit of processor 202. The embodiments are not limited in this context.

In various embodiments, device 100 may include a transceiver 130. Transceiver 130 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1xRTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, device may include a mass storage device 140. Examples of mass storage device 140 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, the device 100 may include one or more I/O adapters 150. Examples of I/O adapters 150 may include Universal Serial Bus (USB) ports/adapters, IEEE 1394 Firewire ports/adapters, and so forth. The embodiments are not limited in this context.

In one embodiment, device 100 may receive main power supply voltages from a power supply 170 coupled to a power source 180 via bus 160. It is to be understood that as illustrated herein, bus 160 may represent both a communications bus as well as a power bus over which the various modules of device 100 may be energized.

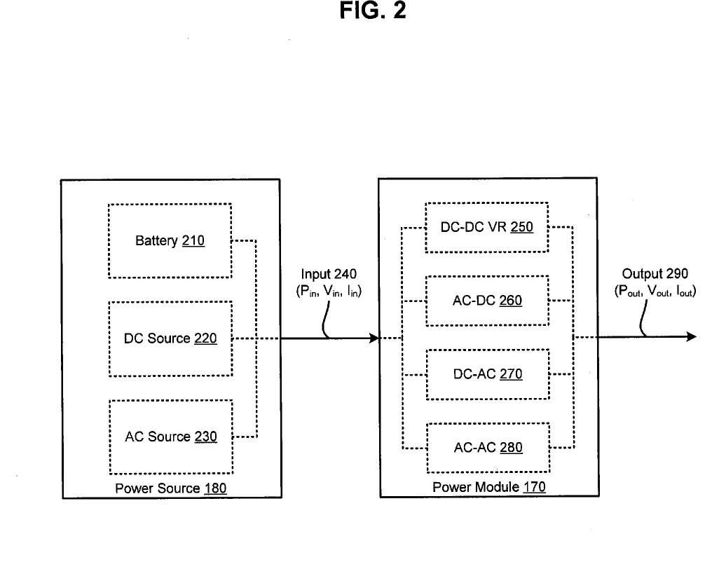

FIG. 2 illustrates the detail of power source 180 and power module 170. For example, the power source 180 may include a battery 210. Battery 210 may be, for example, a zinc carbon battery, an alkaline battery, a nickel cadmium battery, a nickel metal hydride battery, a lithium ion battery, a lead acid battery, a metal air battery, a silver oxide battery, a mercury oxide battery, or any other battery type. In lieu of or in addition to the battery 210, the power source may further include a DC source 220, an AC source 230, or both a DC source 220 and an AC source 230. The embodiments are not limited in this context.

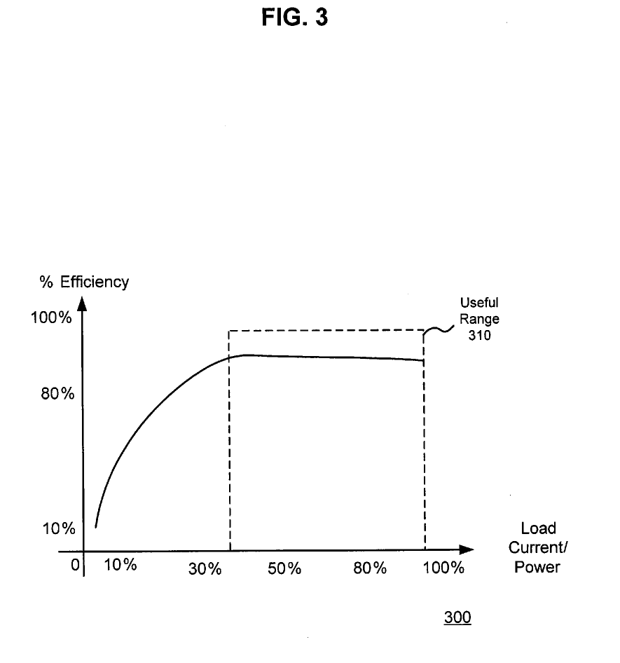

The power source 180 output (e.g., from battery 210, DC source 220, AC source 230, or combination thereof) is the input 240 to the power module 170. Based on the input 240 and the output 290 required by the device 100, the power supply may include a DC to DC voltage regulator 250, an AC to DC converter 260, a DC to AC converter 270, an AC to AC regulator 280 or a combination thereof. In general operation, the power module 170 of an embodiment may receive input 240 from power source 180 and efficiently regulate, convert, or otherwise alter input 240 to generate output 290. In an embodiment, the power module 170 of an embodiment efficiently operates substantially across an entire range of loads (power, current, voltage, or a combination thereof) to be coupled to the output 290. FIG. 3 through FIG. 8 will more specifically describe the architecture and resulting efficiency of the power module 170 of an embodiment.

FIG. 3 illustrates the efficiency curve 300 of a power module or combination of substantially similar or identical power modules in parallel. For such an architecture, the efficiency may be optimized for a particular load range. As indicated by approximate useful range 310 of the efficiency curve 300, the power module or combination of substantially similar or identical power modules may only be useful over a portion of the load range. Often, as illustrated, the power module or combination of substantially similar or identical power modules is optimized at, for example at approximately 75% of the maximum load. However, at smaller loads and larger loads, the performance of the power module or combination of substantially similar or identical power modules may decline. For example, the efficiency of the power module or combination of substantially similar or identical power modules may substantially decline when the load is, for example, less than approximately 30% of the maximum load. Further the efficiency of the power module or combination of substantially similar or identical power modules may substantially decline when the load is, for example, more than approximately 85% of the maximum load

For systems that operate predominantly at a substantially fixed load or approximately around 75% of their maximum load, the efficiency curve 300 of FIG. 3 may represent a power module that may be acceptable. However, when a system (e.g., device 100) operates with greater load fluctuation, the efficiency curve 300 may illustrate a power module that may not have acceptable efficiency for relatively small loads (e.g., approximately ≦30% of maximum load) or relatively large loads (e.g., approximately ≧85% of maximum load).

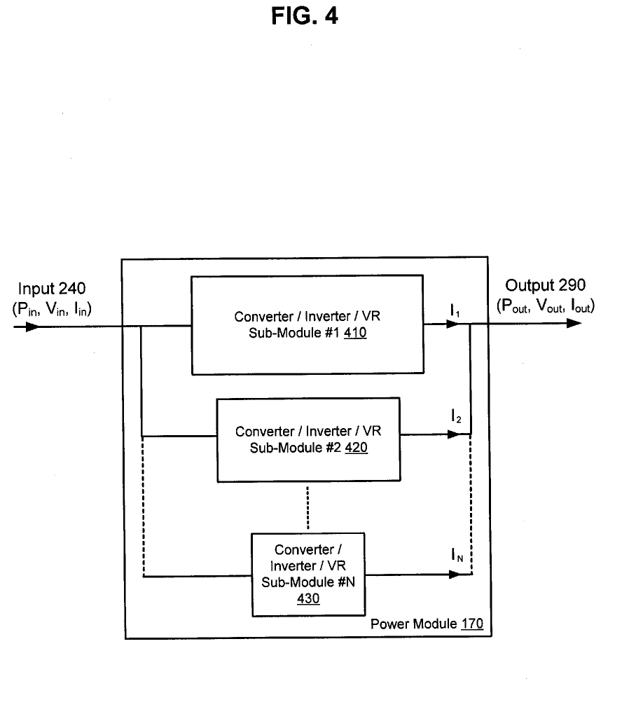

FIG. 4 illustrates a block diagram of power module 170 of an embodiment that employs multiple power sub-modules. In an embodiment, N power sub-modules (shown as sub-module 1 410, sub-module 2 420, and sub-module N 430) may be connected in parallel sharing the same input 240 and the same output 290. The power sub-modules 410-430 may be DC to DC regulators, AC to DC converters, DC to AC converters, or AC to AC regulators as noted with respect to FIG. 2. In an embodiment, each of the power sub-modules 410-430 may have a different size or efficient power/current range so that the first sub-module 410 is larger (and efficient at a higher power/current) than the second sub-module 420, the first and second sub-modules are larger (and efficient at a higher power/current) than the third, and so on up to power sub-module N.

Each of the power sub-modules (e.g., power sub-modules 410-430) of power module 170 of an embodiment may be selected to operate efficiently at different current/power ranges. Further, the power module 170 of an embodiment can be adapted to various power/current load requirements by, for example, enabling or disabling individual or combinations of individual power sub-modules. In an embodiment, for example, when operating at substantially a full load, all of the power sub-modules (e.g., power sub-modules 410-430) may be enabled to deliver the full power/current to the load with their individual maximum or substantially close to maximum capability. Alternatively, when operating at a lighter load, one or more power sub-modules of power module 170 may be disabled such that the remaining power sub-module or power sub-modules may operate in a power/current range for which they are efficient. The enablement and disablement of individual power modules (e.g., power sub-modules 410-430) may further be dynamically controlled to dynamically adapt to changing load requirements. In this manner, the enablement/disablement of individual power sub-modules (e.g., power sub-modules 410-430) may be adapted to improve the overall efficiency of the power module 170 across the load power/current range. Additionally, the power sub-modules 410-430 may be driven/controlled to be in phase or out of phase (e.g., multiphase) with each other to minimize output ripples and improve transient response.

In an embodiment, each power sub-module (e.g., power sub-modules 410-430) of power module 170 may incorporate design parameters that may improve the efficiency of the power module for its range of operation. Design parameters may include components and switches selection, inductor design, switching frequency, gate drive voltage, or different input voltage from a power source.

In an embodiment, each power sub-module (e.g., power sub-modules 410-430) may be a Buck converter, one channel of multiphase Buck converter, or more generally any power stage. Further, individual power sub-modules may be of varying type depending on their range of operation. The embodiments are not limited in this context.

As an example, the output 290 current required by a load may range approximately between 0 A and 60 A. Further, the power module 170 of an embodiment may include three parallel power sub-modules 410-430. Power sub-module 410 may be designed for maximum efficiency at 30 A, power sub-module 420 for 20 A, and power sub-module 430 for 10 A for a total efficient current capacity of 60 A. Assuming the efficiency curve of each power sub-module resembles efficiency curve 300 of FIG. 3, power sub-module 410 may have its highest efficiency when it operates at above approximately 12 A, power sub-module 420 when it operates at above approximately 8 A, and power sub-module 430 when it operates above approximately 4 A. Further, with such a configuration, the ratio of current sharing among the three power sub-modules may be, for example, 3:2:1 for power sub-modules 410-430 respectively. Table 1 illustrates a possible current/power sharing control scheme.

TABLE 1

| | Power Sub- | Power Sub- | Power Sub- |
|---|---|---|---|
| Load Current | Module 430 | Module 420 | Module 410 |
| (A) | (10A) | (20A) | (30A) |
| 0-10 | ON | OFF | OFF |
| 10-20 | OFF | ON | OFF |
| 20-30 | ON | ON | OFF |
| 30-40 | ON | OFF | ON |
| 40-50 | OFF | ON | ON |
| 50-60 | ON | ON | ON |

This control table illustrates an example of power module 170 for which the appropriate power sub-module 410-430 is turned ON or OFF (e.g., enabled and disabled) depending on the required load current so that each individual power sub-module 410-430 may be utilized in its maximum efficiency range. It is to be understood that the example of Table 1 may be extended to additional power modules and alternate load currents or load requirements within the scope of an embodiment.

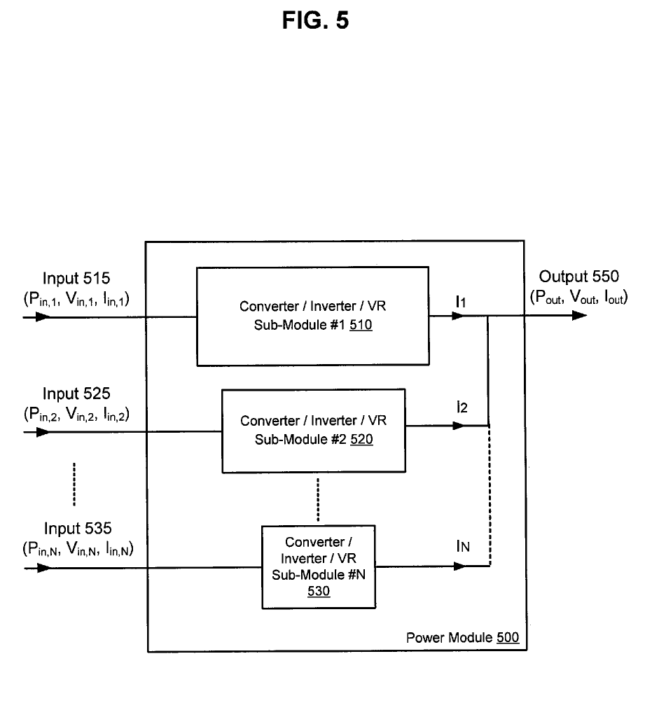

FIG. 5 illustrates power module 500 of an embodiment for which each power sub-module (e.g., power sub-modules 510-530) has a separate input (e.g., inputs 515-535 respectively). Compared to the power module 170 of an embodiment for which power sub-modules 410-430 are all coupled to the same input 240, power module 500 may provide additional flexibility, for example by independently altering the voltages of inputs 525-535, to further improve the overall efficiency of power module 500 across a broader range of loads. For example, it may be that the power sub-modules designed for small loads (e.g., power sub-module 530) may operate more efficiently at a voltage different than the voltage at which power sub-modules designed for large loads (e.g., power sub-module 510) may operate.

For both power modules 400 and 500 of FIG. 4 and FIG. 5, each power sub-module (e.g., power sub-modules 410-430 and 510-530) can have its own independent design parameters. For example, and among other parameters, each power sub-module may have a different input voltage, switching frequency, inductor and capacitor values, switch driving voltage and current, and switch parasitics mitigation. Further, Each power sub-module in the power modules 400 and 500 may include a different power processing topology and circuitry that is suited for specific power range. Additionally, each power sub-module be controlled with a different control scheme including, for example, fixed frequency pulse width modulation (PWM) control, variable frequency PWM control, hysteretic control, and variable frequency resonant control.

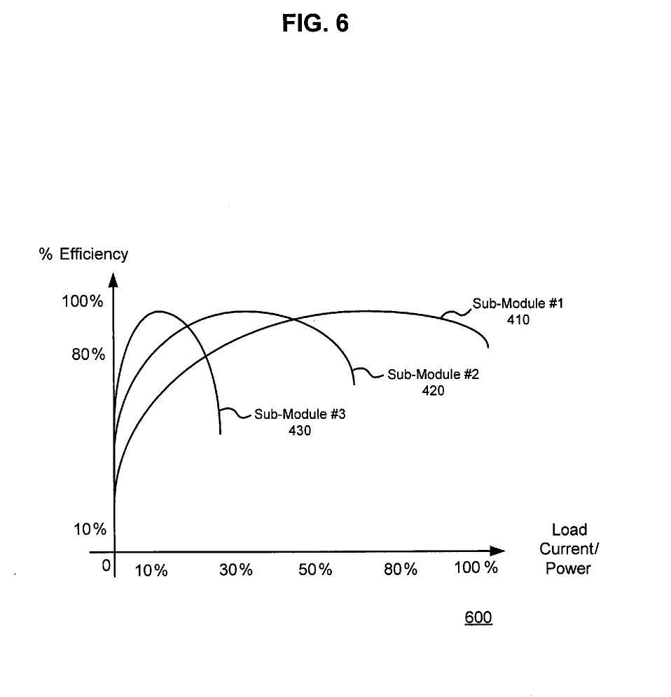

FIG. 6 illustrates the efficiency curves of, for example, power sub-modules 410-430 comprising power module 170 of an embodiment. As illustrated, power sub-module 410 is more efficient at higher loads relative to a maximum load, sub-module 430 is more efficient at lower loads relative to the maximum load, and sub-module 420 is more efficient at a load between the loads at which sub-modules 410 and 430 are efficient. Said alternatively, each of the power sub-modules 410-430 has a different peak efficiency. As noted with respect to Table 1, depending on a particular load, the power sub-modules 410-430 may be implemented individually or in combination to improve the overall efficiency of power module 170.

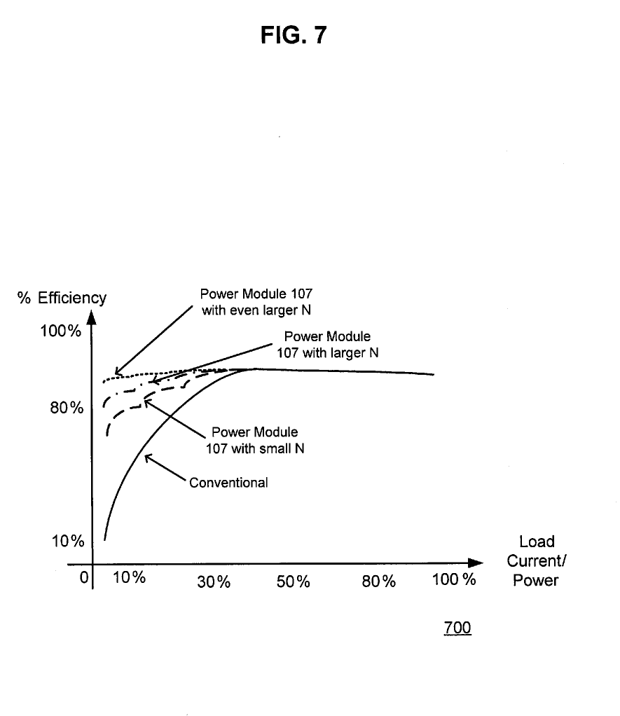

FIG. 7 illustrates efficiency graph 700 including efficiency curves for combinations of individual power sub-modules (e.g., power sub-modules 410-430). As illustrated, the conventional curve may represent a single power module or combination of substantially similar or identical power modules in parallel, such as illustrated by FIG. 3. The additional curves may represent, for example, power module 170 of an embodiment with a variable number of power sub-modules (e.g., N power sub-modules) according to an embodiment. As noted, each additional power sub-module may be efficient at a smaller load than its preceding power sub-module. Accordingly, power module 170 of an embodiment may be increasingly efficient at lower loads relative to the maximum load for an increasing number N of power sub-modules. The overall result is that power module 170 of an embodiment may have a wider total efficiency curve (e.g., a wider range of loads across which power module 170 is efficient) compared to power modules not similarly designed.

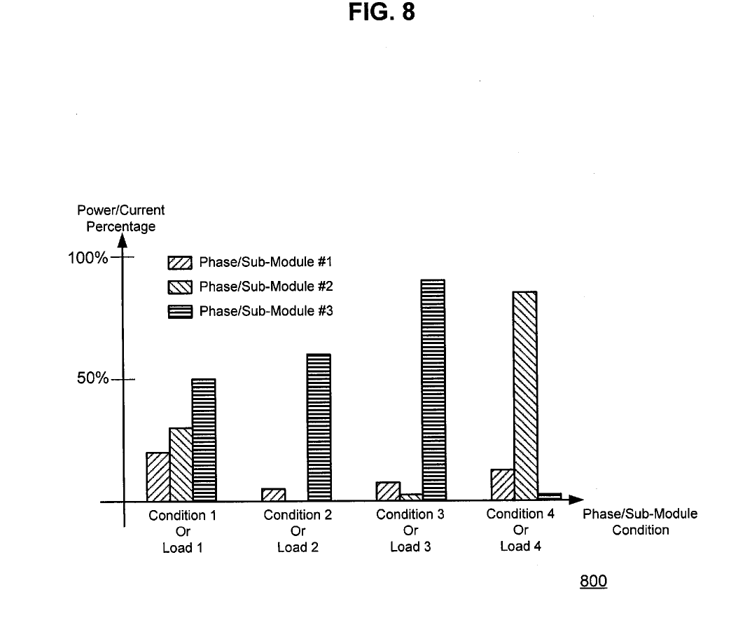

FIG. 8 illustrates graph 800 depicting an alternate embodiment employing non-linear and non-uniform current/power sharing such that the amount of power/current handled by each power sub-module is varied dynamically, or in other words, current/power sharing percentage/ratio is changed dynamically. For example, an embodiment may be implemented by changing the current/power reference for each sub-module dynamically based on load demands and/or other operating conditions. An example of an embodiment is that for a certain load and/or other operating condition(s), the first power sub-module (e.g., power sub-module 430 or 530) may process 20% of the power/current, the second power sub-module (e.g., power sub-module 420 or 520) may process 30% of the power/current, and the third power sub-module (e.g., power sub-module 410 or 510) may process 50% of the power/current. In an embodiment, when load and/or other operating condition(s) change, the power sub-modules 410-430 or 510-530 may be adjusted dynamically so that the first power sub-module processes 5% of the power/current, the second power sub-module processes 35% of the power/current, and the third power sub-module processes 60% of the power/current, and so on. The non-uniform, non-linear adaptive and dynamic current sharing can be further implemented in conjunction with the non-linear ON/OFF scheme as illustrated by Table 1.

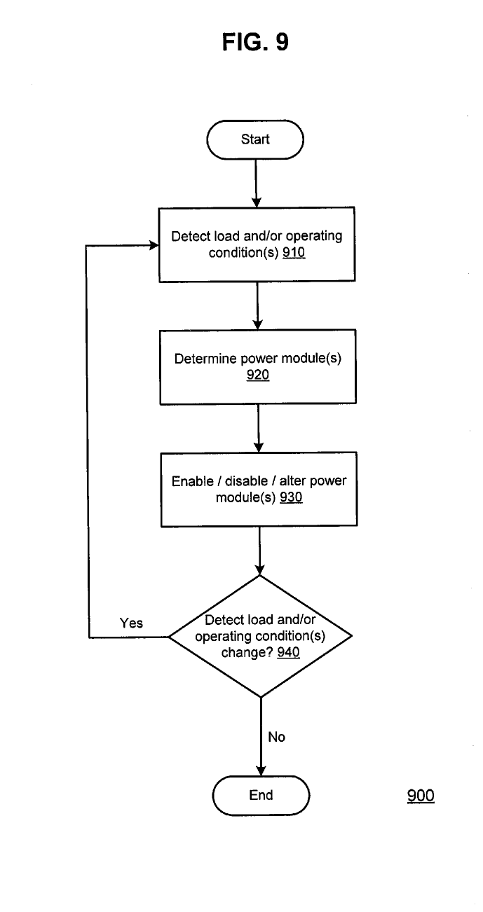

FIG. 9 illustrates a logic flow 900 of an embodiment. At 910, a load (for example at output 290 or output 550) and/or other operating condition(s) may be detected. Depending on the load and/or other operating condition(s) detected, at 920 it is determined which individual power sub-modules, or combination of power sub-modules, is the most efficient for the detected load or other operating condition(s). The determination may, for example, reference a lookup table that contains, like Table 1 for example, what individual power sub-modules or combination of power sub-modules is appropriate for the detected load and/or other operating condition(s). Alternatively, the determination may employ non-linear and non-uniform current/power sharing such that the amount of power/current handled by each sub-module is varied dynamically, or in other words, current/power sharing percentage/ratio is changed dynamically among the multiple power sub-modules. For example, this can be implemented by changing the current/power reference for each sub-module dynamically based on load demands and/or other operating condition(s). Thereafter, at 930, and in response to the determination at 920, individual power sub-modules are enabled, disabled, or otherwise altered (e.g., by changing the current sharing ratio among multiple enabled power sub-modules) to efficiently support the load and/or other operating condition(s). Thereafter, at 940, if a change is detected in the load and/or other operating condition(s), the logic flow 900 loops back to 910 to dynamically adjust to the changed load and/or other operating condition(s). Accordingly, a power module 170 operating according to logic flow 900 may exhibit improved efficiency, and in particular improved efficiency at lower loads relative to a maximum load, as described above.

In various embodiments, each of the power modules (e.g., power modules 170 and/or 500) and/or power sub-modules (e.g., power sub-modules 250-280 and/or 410-430) may be implemented using any number or type of power stages or power processing blocks desired to produce a given output. Examples of such power stages or power processing blocks may include the DC-DC voltage regulator 250, the AC-DC converter 260, the DC-AC converter 270, or the AC-AC voltage regulator 280, as noted with reference to FIG. 2. Further, each of the power module 170 and/or power sub-modules may be implemented using different power stage or power processing types, even in the same module that has only one coupled output.

In various embodiments, a power module and/or power sub-module may be implemented with multiple power stages. In one embodiment, for example, one of the power sub-modules may be implemented as an AC-DC converter power sub-module having at least two stages, with the first stage implemented as the AC-DC converter 260, and the second stage implemented as the DC-DC voltage regulator 250, with the AC-DC converter 260 supplying the DC-DC voltage regulator 250.

In various embodiments, a power module and/or power sub-module may be implemented with multiple power stages in a non-uniform manner. In one embodiment, for example, a power module may be arranged to alter the current or power sharing ratio among the multiple stages of the multiple stage power sub-module in a non-uniform manner. In this manner, the current or power sharing between stages inside the same sub-module can be adjusted non-uniformly as it is adjusted between the sub-modules.

In various embodiments, a power module and/or power sub-module may be implemented using various types of circuit topologies. As previously described, each power sub-module (e.g., power sub-modules 250-280 and/or 410-430) may be implemented as a Buck converter, one channel of multiphase Buck converter, or more generally any power stage. Some additional examples of suitable circuit topologies may include without limitation boost, buck-boost, Sepic, Cuk, forward, flyback, half-bridge, full-bridge, and so forth. Individual power sub-modules may be of varying type depending on their range of operation, and the embodiments are not limited in this context.

In various embodiments, a power module and/or power sub-module may be implemented using an isolated architecture, non-isolated architecture, or a combination of isolated and non-isolated architectures.

In various embodiments, a power module and/or power sub-module may be implemented using different power conversion types and topologies. This includes those embodiments where a power module is coupled to one output.

In various embodiments, a power module and/or power sub-module can share certain parts, components or circuitry. For example, the parts of multiple power sub-modules may be magnetically coupled, electrically coupled, or non-coupled as desired for a given implementation.

In various embodiments, a power module and/or multiple power sub-modules can be coupled to different inputs, as shown with reference to the power module 500 described with reference to FIG. 5. In this case, the input source to each power sub-module can be of same power type and form, or different power type and form, as desired for a given implementation. Examples of input sources may include DC power, AC power, rectified AC power, or other desired power or waveform shapes.

In various embodiments, a power module and/or multiple power sub-modules may be implemented with a multiple cell battery 210. In this case, each power sub-module input can be from a different cell of the multiple cell battery 210 to provide different input voltage levels. For example, each input may be tapped at a different connection within the same battery pack, thereby forming different input power levels from the same battery pack.

In various embodiments, a power module and/or power sub-module may be dynamically and adaptively adjusted. In one embodiment, for example, a power module and/or power sub-module may be arranged to selectively and dynamically enable, disable, or alter the current or power sharing ratio among each power sub-module based on at least one of variable conditions, including load conditions, input power condition, temperature variations, component variations, fault condition in part of the circuit, or other suitable conditions, in order to generate an output capable of the operating condition. The current or power ratio may be dynamically adjusted in an attempt to improve or maximize operating efficiency under all conditions, improve or maximize dynamic performance under all conditions, improve reliability, improve or maximize performance per Watt, and so forth.

In various embodiments, a power module and/or power sub-module may dynamically adjust the current or power sharing ratio based on various types of sensed information. Examples of sensed information may include without limitation voltage information, current information, power information, and so forth. A power module and/or power sub-module may also dynamically adjust the current or power sharing ratio based on signals from a processor, or alternatively, based on values or signals stored by a look up table.

In various embodiments, a power module and/or power sub-module may operate on different sets of fixed and/or variable parameters. Examples of such fixed and/or variable parameters may include without limitation parameters such as fixed frequency, variable frequency, fixed drive voltage, variable drive voltage, inductance, number of switches, type of switches, and other desired fixed and/or variable parameters.

In various embodiments, a power module and/or power sub-module may utilize multiple static and/or dynamic current or power sharing ratios. In one embodiment, for example, a first set of power sub-modules may be implemented with a first fixed current or power sharing ratio, while a second set of power sub-modules may be implemented with a second fixed current or power sharing ratio. In one embodiment, for example, a first set of power sub-modules may be implemented with a fixed current or power sharing ratio, while a second set of power sub-modules may be implemented with a variable or dynamic current or power sharing ratio, or vice-versa. In one embodiment, for example, a first set of power sub-modules may be implemented with a first variable or dynamic current or power ratio, while a second set of power sub-modules may be implemented with a second variable or dynamic current or power sharing ratio.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, such as the examples given with reference to FIG. 2. For example, the memory unit may include any memory device, memory article, memory medium, storage device, storage article, storage medium and/or storage unit, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. An apparatus comprising:
a power module including a plurality of power sub-modules, each power sub-module to have a peak efficiency at a different operating condition.

2. The apparatus of claim 1, the power module to selectively enable, disable, or alter the current sharing among each power sub-module based on at least one of peak efficiency, steady-state performance, or dynamic performance of each power sub-module, to generate an output capable of the operating condition.

3. The apparatus of claim 2, the power module to further selectively enable, disable, or alter the current sharing among each power sub-module dynamically in response to a change in the operating condition.

4. The apparatus of claim 3 wherein the power sub-modules are coupled to a single input and wherein the power sub-modules are coupled to the output.

5. The apparatus of claim 3 wherein each power sub-module is coupled to a separate input and wherein the power sub-modules are coupled to the output.

6. A system comprising:
a battery; and
a power module coupled to the battery, the power module including a plurality of power sub-modules, each power sub-module to have a peak efficiency at a different load.

7. The system of claim 6, the power module to selectively enable, disable, or alter the current sharing ratios among each power sub-module based on at least one of peak efficiency, steady-state performance, or dynamic performance of each power sub-module to generate an output capable of the operating condition.

8. The system of claim 7, the power module to further selectively enable, disable, or alter the current sharing among each power sub-module dynamically in response to a change in the operating condition.

9. The system of claim 8 wherein the power sub-modules are coupled to a single input and wherein the power sub-modules are coupled to the output.

10. The system of claim 8 wherein each power sub-module is coupled to a separate input and wherein the power sub-modules are coupled to the output.

11. A method comprising:
detecting, by a power module including a plurality of non-identical power sub-modules, a load;
determining, by the power module, the power sub-module or power sub-modules to supply the load; and
selectively controlling, in response to determining, the power sub-module or power sub-modules.

12. The method of claim 11, selectively controlling the power sub-modules further comprising:
altering the current or power sharing among the power sub-modules.

13. The method of claim 11, selectively controlling the power sub-module or power sub-modules further comprising:
controlling the sub-module or sub-modules with fixed frequency pulse width modulation (PWM) control, variable frequency PWM control, hysteretic control, or variable frequency resonant control.

14. The method of claim 12 further comprising:
detecting, by the power module, another load.

15. The method of claim 14 further comprising;
determining, by the power module, the power sub-module or power sub-modules to supply the other load; and
selectively controlling, in response to determining, the power sub-module or power sub-modules.

16. An article comprising a machine-readable storage medium containing instructions that if executed enable a system to:
detect, by a power module including a plurality of non-identical power sub-modules, a load;
determine, by the power module, the power sub-module or power sub-modules to supply the load; and
selectively control, in response to the determination, the power sub-module or power sub-modules.

17. The article of claim 16 further comprising instructions that if executed enable the system to:
alter the current or power sharing among the power sub-modules.

18. The article of claim 16 further comprising instructions that if executed enable the system to:
selectively control the power sub-module or power sub-modules with fixed frequency pulse width modulation (PWM) control, variable frequency PWM control, hysteretic control, or variable frequency resonant control.

19. The article of claim 17 further comprising instructions that if executed enable the system to:
detect, by the power module, another load.

20. The article of claim 19 further comprising instructions that if executed enable the system to:
determine, by the power module, the power sub-module or power sub-modules to supply the other load; and
selectively control, in response to the determination, the power sub-module or power sub-modules.

21. The apparatus of claim 1, said power sub-modules comprising a DC-DC voltage regulator, an AC-DC converter, a DC-AC converter, or an AC-AC voltage regulator.

22. The apparatus of claim 1, said power sub-modules including a two-stage AC-DC converter having an AC-DC converter first stage supplying a DC-DC voltage regulator second stage.

23. The apparatus of claim 1, said power sub-modules including a power sub-module having multiple stages, with said power module altering the current or power sharing ratio among the multiple stages of the multiple stage power sub-module in a non-uniform manner.

25. The apparatus of claim 1, wherein each power sub-module is isolated, non-isolated or a combination of both isolated and non-isolated.

26. The system of claim 10, wherein each input to each power sub-module can be of same power type and form or of a different power type and form.

27. The system of claim 10, wherein each input may comprise DC power, AC power or rectified AC power.

28. The system of claim 6, wherein said battery comprises a multiple cell battery, with each power sub-module receiving input from a different cell to provide different input voltage levels.

29. The apparatus of claim 1, the power module to selectively and dynamically enable, disable, or alter the current sharing among each power sub-module based on at least one of variable conditions including load conditions, input power condition, temperature variations, component variations, or fault condition in part of the circuit, to generate an output capable of the operating condition.

30. The apparatus of claim 1, the power module to selectively and dynamically enable, disable, or alter the current sharing among each power sub-module based on sensed information including voltage, current, or power.

31. The apparatus of claim 1, the power module to selectively and dynamically enable, disable, or alter the current sharing among each power sub-module based on signals from a processor.

32. The apparatus of claim 1, the power module to selectively and dynamically enable, disable, or alter the current sharing among each power sub-module based on values from a look up table.

33. The apparatus of claim 1, wherein two or more power sub-module operate using a different set of fixed or variable parameters, said parameters including at least one of fixed frequency, variable frequency, fixed drive voltage, variable drive voltage, inductance, number of switches, or type of switch.

34. The apparatus of claim 1, the power module to selectively and dynamically enable, disable, or alter the current sharing among each power sub-module of a first set of the power sub-modules using a first current or power sharing ratio, and a second set of the power sub-modules using a second current or power sharing ratio.
